(19) United States
(12) Patent Application Publication
(10) Pub. No.: US 2010/0043286 A1
(43) Pub. Date: Feb. 25, 2010

(54) METHOD AND DEVICE FOR PRODUCING ANNUAL REPRODUCTION MATERIAL FOR TREE NURSERIES, AS YOUNG ROOTS FOR IMMEDIATE PLANTING

(76) Inventor: Jenö Nemeth, Fertoszentmiklos (HU)

Correspondence Address: SPECKMAN LAW GROUP PLLC, 1201 THIRD AVENUE, SUITE 330, SEATTLE, WA, 98101, US

(21) Appl. No.: 12/515,937

(22) PCT Filed: Nov. 22, 2007
(86) PCT No.: PCT/HU2007/000111

§ 371 Date: May 21, 2009

(30) Foreign Application Priority Data
Nov. 23, 2006 (HU) P0700279
Nov. 23, 2006 (HU) U0600256

(51) Int. Cl. A01G 3/00

(52) U.S. Cl. 47/1.1 R; 47/58.1 R

(57) ABSTRACT

The invention method for production of one year old nursery propagation material, having undercut quality and branched root system, ready to plant, applying the usual soil preparation, water- and nutrient addition and plant protection—where at spring of the first year, near to the surface on the root system (11) of the plant (9), sprout 1-2 months before—sowed advantageously in bed, or in rows—early undercutting will be carried out advantageously in 5-7 cm-s cutting depth (16) from the soil level (10). The root system of the plant, produced with the early undercutting method can be recognized from its branched root system (14), starting from 5-10 cm-s (16) to the ground level.

The equipment, realizing the early undercutting belongs also to the invention that has a tearing accessory. It is typically formed from vertical coulters (5a, 5b) fixed stiffly to the supports (3a, 3b), and tense horizontal cutting threads (6), fixed with detachable fixing elements on the lower part of the coulters—from twisted steel wire, wire thread, nylon string, or thin saw edge.

### REFERENCE TO RELATED APPLICATIONS

This application is the US national phase entry of International Patent Application No. PCT/HU2007/000111, filed Nov. 22, 2007, which claims priority to Hungarian Patent Applications No. U0600256 and P0700279, both filed Nov. 23, 2006.

### FIELD OF THE INVENTION

The invention is suitable for production of one year old nursery propagation material—ready to plant—with one time or frequent undercutting of the root system of the seedling, or cutting near the surface. Furthermore, it is suitable for undercutting the roots of the seedlings, (grown in beds or rows), near the surface with equipment (mechanization of the process) having a horizontal cutting thread. With this method, a one year old seedling with a branched root system, in undercut and ready to plant quality, can be produced. The method can be applied in forestry nurseries, and it is the most favourable for economical and good quality field production of propagation material of tap-root tree species.

### BACKGROUND OF THE INVENTION

The main goal of forestry nurseries is the production of propagation material that can be handled easily and has good survival rate, in larger quantities, with lower costs, and, if possible, with a shorter growing season. According to the experience, the quality of the seedling is good, if it can be transported and planted out with a root system, which is less unharmed and has a larger active-working surface (namely with so called branched root system).

Considering the root system, the nurseries—applying the traditional cultivation method—can achieve less good quality. In order to produce seedlings having richer fine root system, with more favourable root-stem ratio, which are more viable, root undercutting, as a method has been used for a long time in the production of propagation material. According to the nursery practice, the seedling production with undercutting needs two years. The undercutting of the root is carried out mechanically after the first vegetation period in autumn or in spring, under the ground level in a depth of 15-20 cm-s. After that the disarranged soil is compacted (trampled in), and irrigated. In spring of the second year forking root development starts on the cut root surface in 15-20 cm-s depth and even with professional production, nutrient-supply, and plant protection, another complete vegetation period is needed to the full development of the seedling in order to have a suitable root system for planting and sale. Thus, in the case of undercutting carried out in the traditional way, at least two years are needed to produce undercut propagation material which has a promising quality.

### SUMMARY OF THE INVENTION

In our invention, root undercutting is not applied in the generally used 15-20 cm depth, on seedlings with already wooded stem and root system, but it is applied significantly earlier, with seedlings having smaller root system, or radicle, to a term when the end of the roots (radicle) still easily break. According to our experiments, the development of the plant will not stop after the undercutting is carried out at that age, and furthermore in the cut section of the root immediate, intense fine root development will start. After a month, the undercutting can be repeated in 10-15 cm depth for establishing more branched root system. With onetime or frequent undercutting, carried out in the early phase of the development within one year, we can get seedlings (ready to plant), having better quality properties, than within two years using the traditional method. Appropriate soil preparation, other cultivation, good irrigation, nutrient supply and plant protection are applied. The seedling produced with early undercutting can be clearly identified by its better branched root system.

The practical depth and time of the undercutting is not determined primarily by the physiological properties of the seedling, but by the properties of the tools used for mechanical cultivation, because the known mechanical tools are not suitable for undercutting closer to the surface, only deeper.

The currently produced and traded tools (e.g.: EGEDAL root undercutting machine)—that are introduced for example on the 35-49 pages of the lecture notes, edited by Dr. Béla Horváth, issued in 2002 by the University of West-Hungary, Faculty for Forestry, Department of Mechanics (NyME Erdömérnöki Kar, Géptani Tanszék)—are such devices, trailed by a motor, which have a cutting knife (moving under the surface) connected to the suspended framework, running on support wheels, through a spacer or a breast plate from one side, or between the two wheels. On the machines which can work in the whole sowing bed width of the tractor mark, the vertical shaft of the cutting knifes, fixed stiffly to the spacers of the suspended framework, cleave the soil in vertical direction, and the middle, horizontal part of the cutting knife cuts the soil and undercuts the root with its edge and horizontal surface plain. The machine has parallel with the surface, in the depth, determined by the supporting wheels, having fixable height, in the width, marked by the vertical shafts. Because of the rubs of the soil, the cutting knife not only cuts the root system, but with its plate, it tips the undercut soil piece which causes the turning out or the pulling in of the seedling at small cutting depth. According to the invention, in the method working with the early undercutting, the root undercutting is applied differently from the generally used 15-20 cm-s depth, at a significantly smaller cutting depth, using modified tools so that the problems caused by the waggling of the plate surface of the cutting knife can be prevented.

According to the invention, the main changes of the tool implementing the early undercutting is that the horizontal cutting knife of the cutting frame is replaced by an accessory that can not deviate, or waggle, from the horizontal plain. The required effect can be obtained, if the horizontal cutting knife is replaced with line-like cutting edge, namely with a tense cutting thread, for example with wire thread, twined steel wire, or tempered, jagged metallic filament, made of flexible alloy, or nylon string. This cutting thread is able to tear the soil and the roots inside it, but it does not have a plane surface, which could lift, or tip out the soil section, so there will be no effect which would cause the seedling to turn out or pull into the soil. The cutting thread can be applied advantageously for tools, having variable working width, or variable trimming angle.

The inventive method is suitable for the production of nursery propagation material that can be planted out a year after undercutting the root system of the seedling or cutting (typically several months old, advantageously 1-2 months old), near to the surface (advantageously in 5-7 cm-s depth). If necessary, the undercutting can be repeated after a month in 10-15 cm-s depth.

The invention also provides equipment that makes it possible to mechanize the process for the root undercutting of plants, sowed in beds or in rows near the surface. The equipment has a suspended framework and tearing accessory, where the suspended framework consists of a towing device with a three-point linkage, spreader fixed generally with welding to the previously mentioned part, and symmetric, or asymmetric spacers (fixed generally with detachable fixing elements) that can be connected to an automatic motor. Gauge wheels that roll on the ground level and can be fixed in adjustable heights, are connected to the spacers. The tearing accessory consists of supports, having vertical plain, fixed stiffly to the spacers—advantageously from steel coulters, having edge—and tense horizontal cutting threads, fixed with detachable fixing elements on the lower part of the coulters—advantageously from twisted steel wire, wire thread, nylon string, or jagged metallic filament.

The plant produced with this process also belongs to the invention. Typically the product is a seedling that has an undercut root system. In the root system the branched part is richer, which can be seen on the part of the roots between 5-10 cm-s to the ground level.

### BRIEF DESCRIPTION OF THE FIGURES

The process, the equipment and its utilization, together with the manufactured product will be with reference to the figures:

FIG. 1: axonometric drawing of the equipment, according to the invention

FIG. 2: schematic drawing of the fresh germinated seedlings

FIG. 3: schematic drawing of the plant that will be undercut traditionally in autumn of the first year,

FIG. 4: the product, cultivated from the plant of FIG. 3, in autumn of the second year

FIG. 5: schematic drawing of the plant which will be undercut early, according to the invention

FIG. 6: the product, created with onetime undercutting from the plant of FIG. 5 in autumn of the first year

FIG. 7: the early undercut plant of FIG. 5 approximately 1 month after the first undercutting, at the ideal time of the repeated undercutting

FIG. 8: the product, cultivated with repeated early undercutting according to FIG. 6 in autumn of the first year.

### DETAILED DESCRIPTION

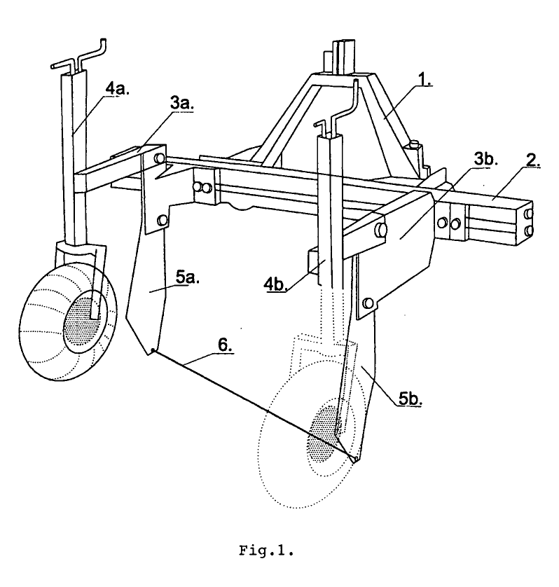

FIG. 1 illustrates the main parts of the root undercutting equipment: the wing device 1 suitable for three-point linkage and forming the suspended framework; the spreader 2, fixed to the wing device with welding; spacers 3a, 3b, fixed to the spreader with screws; the gauge wheels 4a, 4b, mounted to the spacers; the coulters 5a, 5b, suspended to the spacers 3a, 3b with screws, forming the tearing accessory; and the cutting thread 6, fixed at connection points formed at the end of the coulters (in order for the structure of the tearing accessory to be more visible, the wheel 4b and its supporting structure are drawn dotted on the drawing). In our case the spreader 2 was made from split profile steel with welded steel handles and bores. According to our experiments, the cutting thread 6 is the most advantageous if it is made from twisted steel wire, but it can be wire, nylon string, or thin saw edge.

In the illustrated embodiment, the spacer 3b is longer than the spacer 3a and their distance on the 2 spreader can be easily modified if necessary (because of the detachable fixing elements). Accordingly, on the one hand the trimming angle of the cutting thread 6 and on the other hand the track width covered at the same time, can be chosen, in which case modification of the length of the cutting thread 6 is also necessary. The depth adjusting spindles, mounted on the supporting structure of the rubber tyre wheels 4a, 4b, make it possible to change the height of the fixable wheels and the height difference between the soil surface and the cutting thread 6. This changes the depth of the advance of the cutting thread 6 in the soil, the so called cutting depth.

The equipment is operated as follows: standing on the planting bed, the angle of the cutting thread 6 compared to the course has to be set and fastened (if necessary) with suitable positioning of the spacers 3a and 3b; the level of the cutting thread 6 compared to the surface has to be set and fastened with help of the depth adjusting spindle. The towing device 1 is then connected to the three-point linkage of an automatic machine—for example a tractor—in the floating position of the hydraulics. When the machine is started, the coulters 5a, 5b—forming the tearing accessory—go vertically in the soil and lead the cutting thread 6 in a constant distance from the ground level. The cutting thread 6 cuts the roots at the required height, without tipping the seedlings, or significantly disarranging the soil. So it is an advantage, compared to other undercutting machines using cutting knife, because the undercutting does not need to be followed by compaction (trampling in), or irrigation. As advantageously the undercutting is carried out in the early development stage of the plant, at 5-7 cm-s depth, when the end of the roots (radicle) still easily break and the soil of the planting bed can be cultivated easily, the cutting thread is not subject to disproportionate load, so it rarely cracks. The applied tearing accessory is especially economical because the addition, change, and size adjustment of the cutting thread is simple, and known undercutting tools can be transformed with a small modification for use this way.

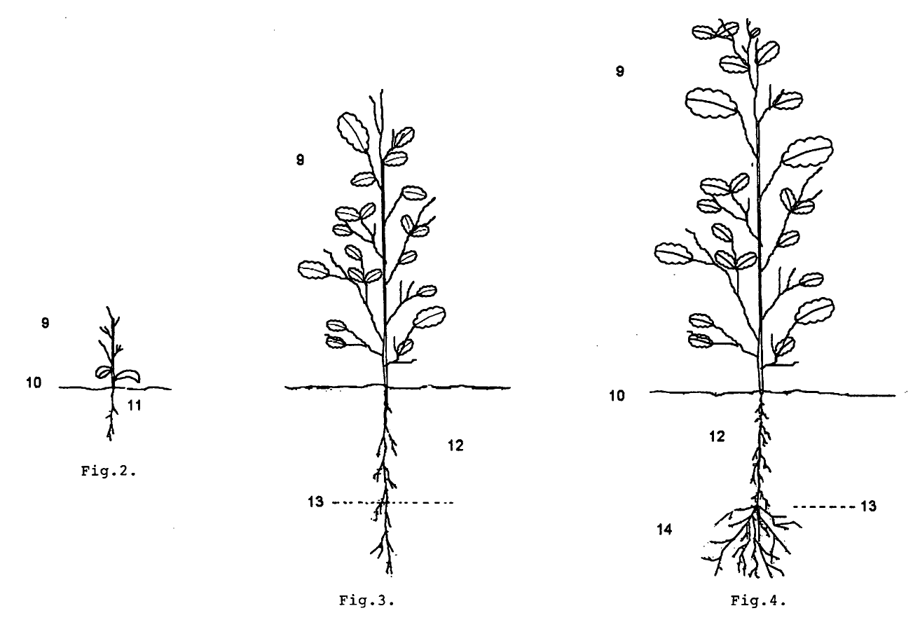

FIG. 2 shows schematically a germinated seedling 9 1-2 months old in the first vegetation year with a short root system 11, formed under the ground 10. The stem and root of the plant 9 becomes woodier and stronger until the end of the first vegetation period. Typically, in the case of tap-root tree species, the plant grows a root system which is long, but with only a few rootlets, as shown on FIG. 3. In order to increase the root-mass and root-surface, and therefore the viability, of the seedling, according to traditional nursery practice, in autumn of the first year, the woody root 12 of the plant will be undercut at 15-20 cm-s depth 13 under the soil level 10 generally with cutting knife, or a cutting knife machine. On the cut root surface, namely at 15-20 cm-s depth, a rootlet development starts, from which—the considerably branched root system 14 (shown in FIG. 4) will develop until the autumn of the next vegetation period. So with the traditional method, at least two vegetation periods are required to produce a ready to plant seedling, in undercut quality. In the case of tap-root type plants, considering the approximately 25 cm root length, the branched root system 14, which is highly necessary from the point of view of survival, represents only the lower third of the root.

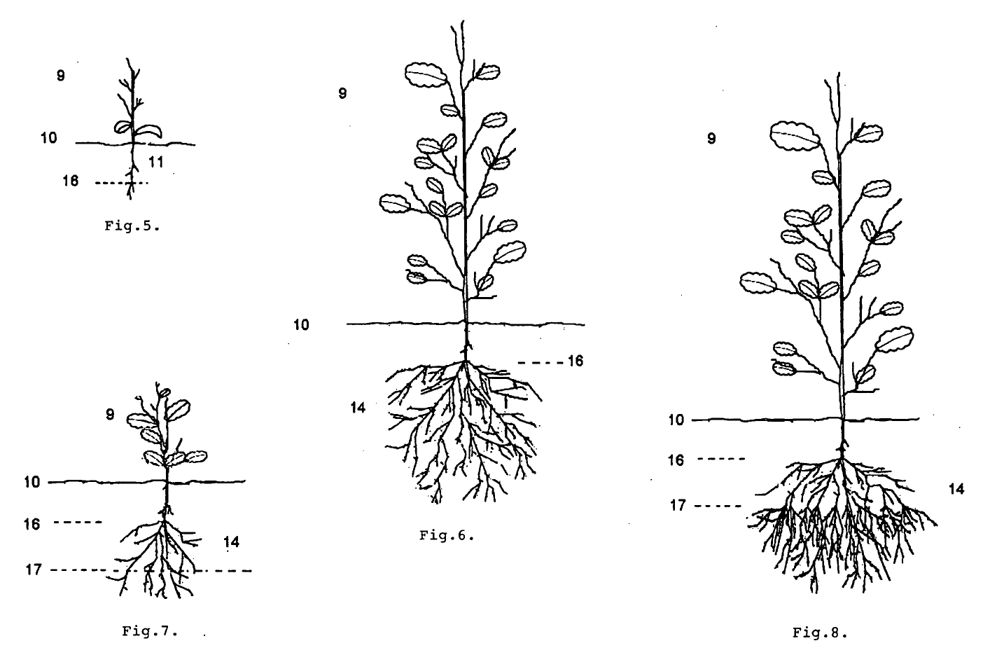

In the schematic drawing of FIG. 5 the plant 9—germinated 1-2 months ago, getting early undercut according to the invention—is shown. The root system 11 of the previously mentioned plant will be undercut under the soil level 10 in approximately 5-7 cm-s depth 16 with cutting thread machine at field breeding. The development of the plant will not stop after the undercutting at that age. Intensive and rich rootlet development starts immediately above the cut place and branched root system 14 will develop, while the part of the seedling above the ground will develop in compliance with the vegetation period, as shown in FIG. 7. The schematic drawing of FIG. 6 presents the seedling—cultivated by early undercutting—at fall of the first vegetation period. If the usual careful cultivation, water- and nutrient supply, if necessary spacing, weed control and plant protection is used, a replantable seedling can be produced (for the autumn of the first year) that already has the branched root system 14 5-10 cm-s under the ground, so its active root surface is many times greater than the seedling produced by the traditional undercutting method. That means that its survival rate is much higher.

FIGS. 7 and 8 show that the result of the undercutting (applied 1-2 months after the germination) is multiplied, if the undercutting is repeated in spring of the first vegetation period, after ca. 1 month in 10-15 cm-s depth 17.

Comparing the seedlings shown on FIGS. 3 and 6 or 8, it is clearly recognizable which and when was treated with undercutting, because the root system gets richer on the undercutting levels in visible scale.

For propagation material produced with the inventive method, plant species that otherwise grow tap-root, characteristically grow ramifying root system. In the case of plant species that otherwise grow ramifying root system, the effective root surface becomes multiple. The plants produced that way can bear the aridity better and do not suffer so much after planting, due to the larger root mass.

### SUMMARY

Using early undercutting according to the invention, we can get a seedling that can be planted out in one year, while by applying the traditional method (undercutting with cutting knife at the traditional date) we can get it only in two years. Compared to the traditional production method, the new method is definitely more economical.

The propagation material produced with the early undercutting method according to the invention characteristically has a larger root mass and therefore represents better quality than the traditionally field cultivated nursery seedlings.

With help of the cutting thread equipment according to the invention, the onetime or frequent undercutting (near the surface) of the seedlings—sowed in bed, or in rows—can be achieved easily. The economic efficiency is intensified by the fact that the addition, change, and/or size adjustment of the cutting thread in the equipment is simple and cheap, and furthermore the known undercutting tools can be transformed to a cutting thread type with a small modification.

The invention has great importance, especially in the mass production of viable and quality propagation material of tap-root plant species.

1-4. (canceled)

5: A method for producing plant propagation material for tree nurseries comprising undercutting a root of a 1-2 month old plant at a depth of between 5-7 cm below soil level.

6: The method of claim 1 further comprising undercutting the root of the plant, at a depth of between 10-15 cm below soil level.

7: A device for undercutting plant roots comprising:
(a) a framework comprising a towing device with a three-point linkage,
(b) a spreader fixed to the framework and having spacers fixed thereto
(c) two wheels connected to the spacers that roll on the ground level and can be fixed at adjustable heights;
(d) a first and a second vertical coulter connected to the spacers; and
(e) a horizontal cutting thread attached at its ends to a lower part of the first and second coulters.

8: Plant propagation material produced according to the method of claim 5.
